(19) United States
(12) Patent Application Publication
(10) Pub. No.: US 2013/0065127 A1
(43) Pub. Date: Mar. 14, 2013

(54) MULTICOMPONENT ELECTRODES FOR RECHARGEABLE BATTERIES

(71) Applicants: Linda Faye Nazar, Waterloo (CA); Xiulei (David) Ji, Waterloo (CA)

(72) Inventors: Linda Faye Nazar, Waterloo (CA); Xiulei (David) Ji, Waterloo (CA)

(21) Appl. No.: 13/607,577

(22) Filed: Sep. 7, 2012

Related U.S. Application Data
(63) Continuation-in-part of application No. PCT/CA2011/050370, filed on Jun. 17, 2011.
(60) Provisional application No. 61/344,240, filed on Jun. 17, 2010.

(51) Int. Cl. H01M 4/58; H01M 4/38

(52) U.S. Cl. CPC H01M 4/5815; H01M 4/38
USPC 429/218.1

(57) ABSTRACT

The present invention pertains to sulfur cathodes for use in an electric current producing cells or rechargeable batteries. The sulfur cathode comprises an electroactive sulfur containing material, an electrically conductive filler and a non-electroactive component. The invention further pertains to rechargeable batteries comprising said sulfur cathode.

### CROSS REFERENCE TO PRIOR APPLICATIONS

The present application is a Continuation in Part of PCT application number PCT/CA2011/050370, filed Jun. 17, 2011, which claims priority from U.S. Provisional application No. 61/344,240, filed Jun. 17, 2010. The entire contents of the aforementioned prior applications are incorporated herein by reference.

### FIELD OF INVENTION

The present invention relates generally to the field of rechargeable batteries and more specifically to rechargeable Lithium-Sulfur batteries. In particular the invention relates to sulfur composite cathodes and their application in rechargeable batteries.

### BACKGROUND OF THE INVENTION

Safe, low cost, high-energy-density and long-lasting rechargeable batteries are in high demand to address pressing environmental needs for energy storage systems. One of the most promising candidates for storage devices is the lithium-sulfur (Li—S) cells. Li—S batteries exhibit unusually high theoretical energy densities, often over 5 times greater than conventional Li ion batteries based on intercalation electrodes. Despite the advantages, wide spread implementation of Li—S batteries remains hindered by various challenges which mainly arise from the sulfur positive electrodes (“cathodes”).

A major problem of Li—S batteries is the rapid capacity fading of the sulfur cathode, mainly due to diffusion followed by dissolution of polysulfide anions (Sₙ, 2-), a series of intermediate reaction species, from the cathode into electrolyte. This dissolution leads to active mass loss on both the negative electrode (“anode”) and the cathode. The polysulfide anions act as redox shuttles as well, which results in lower coulombic efficiency, namely, a much larger charge capacity than the corresponding discharge capacity.

Several approaches have been proposed in the art to address the polysulfide anion diffusion problem. Another approach is to tether sulfur to polymeric molecules. Such an approach has been investigated and disclosed in U.S. Pat. Nos. 4,833,048; 5,162,175; 5,460,905, 5,462,566, 5,516,598; 5,529,860; 5,601,947; 5,690,702; 6,117,590; 6,174,621; 6,201,100; 6,309,778 and 6,482,334. Another approach is to add electrically porous conductive agents into the cathode. Such an approach has been investigated and disclosed in U.S. Pat. Nos. 6,194,099; 6,210,831; 6,406,814; 6,652,440; 6,878,488 and 7,250,233. U.S. Pat. Application No. 2009/0311604 described encapsulating sulfur active mass in porous carbon before cycling the batteries. Another approach is to use polymer binders for retarding polysulfide diffusion. Such an approach has been investigated and disclosed in U.S. Pat. Nos. 6,110,619; 6,312,853; 6,566,006 and 7,303,837. A further approach is to employ physical barriers to block polysulfide ions from diffusion. Such an approach has been investigated and disclosed in U.S. Pat. No. 7,066,971. Still a further approach is to employ separators for retarding polysulfide diffusion. Such an approach has been investigated and disclosed in U.S. Pat. Nos. 6,153,337; 6,183,901; 6,194,098; 6,277,514; 6,306,545; 6,410,182 and 6,423,444. Another approach is to employ cathode current collectors for retarding polysulfide diffusion. Such an approach has been investigated and disclosed in U.S. Pat. No. 6,403,263. Still another approach is to use additives in the electrolyte. Such an approach has been investigated and disclosed in U.S. Pat. Nos. 5,538,812; 6,344,293; 7,019,494; 7,354,680 and 7,553,590.

Physical bathers have not completely solved the polysulfide dissolution problem in long term cycling. A fast responding sulfur battery requires facile transport of electrolyte/Li+into and out of the sulfur electrode, and eventually some soluble polysulfide ions will diffuse out of the porous carbon chambers, which initiates the shuttle phenomenon. Once polysulfide ions diffuse out of the cathode and into the electrolyte, their reaction with the anode will cause active mass loss. Despite the various approaches previously proposed, there remains a need for a solution to prevent or inhibit polysulfide ions from diffusing out of the cathode and into the electrolyte.

### SUMMARY OF THE INVENTION

One aspect of the invention relates a sulfur cathode for use in a rechargeable battery, the cathode comprising:
(a) an electroactive sulfur containing material;
(b) an electrically conductive filler and
(c) a non-electroactive component;
wherein the non-electroactive component is porous, and has one or more of:
   i) pore dimensions that permit absorption of a polysulfide anion and
   ii) active sites for polysulfide adsorption; and
   wherein the absorption and/or adsorption is reversible.

Another aspect of the invention relates to a rechargeable battery comprising:
a. an anode,
b. a separator,
c. a non-aqueous electrolyte and
d. a sulfur containing cathode comprising:
   (a) an electroactive sulfur containing material;
   (b) an electrically conductive filler and
   (c) a non-electroactive component;
      wherein the non-electroactive component is porous, and has one or more of:
      i) pore dimensions that permit absorption of a polysulfide anion and
      ii) active sites for polysulfide adsorption; and
      wherein the absorption and/or adsorption is reversible.

### BRIEF DESCRIPTION OF THE DRAWINGS

The features of the invention will be described in relation to the appended drawings in which:

FIG. 1 shows the cycle life characteristics of a cathode using a molecular sieve as an additive.

FIG. 2 shows the morphology of an additive, SBA-15, a mesoporous silica.

FIG. 3a shows the absorption and desorption isotherm of silica colloidal monolith (SCM) and the pore size distribution, (inset) indicating pore structure centered at 12.5 nm.

FIG. 3b shows a high resolution scanning electron microscope (SEM) image of SCM.

FIG. 3c shows a dark-field scanning transmission electron microscopy (STEM) image of SCM that reveals a homogeneous pore size.

FIGS. 3d and 3e show high resolution SEM and dark-field STEM images of SCM/S indicating the effect of sulfur imbibitions into the pore structure.

FIG. 3f shows the morphology of composite cathode comprising elemental sulfur, carbon filler SCM, and SBA-15 additive.

FIG. 4 shows the first galvanostatic discharge-charge profiles of the first cycle of cells with and without SBA-15 additive.

FIG. 5 shows a comparison of the cycle life characteristics of a cathode with mesoporous silica as an additive (circles) and without (triangles).

FIG. 6 shows SEM results of SBA-15 added SCM/S electrode at different cell voltages with corresponding energy dispersive X-ray spectroscopy (EDX) results collected from the area marked in rectangle shown at the left bottom corner of images a) first time discharged to 2.15 V b) first time discharged to 1.5 V.

FIG. 7 shows percentage of sulfur dissolution into the electrolyte from: the SCM/S cathode (solid dot curve); from the SBA-15 added SCM/S cathode (empty dot curve).

FIG. 8 shows schematic diagram showing the absorption effect of SBA-15 rods in SCM/S electrode on polysulfide anions.

FIG. 9 shows the cycle life characteristics of a cathode with no additives.

FIG. 10 shows an SEM image of the SCM carbon.

FIG. 11 shows BET isotherms of SBA-15 (top), α-TiO₂ (middle) and β-TiO₂ (bottom).

FIG. 12 Long term cycling performance of SCM/S-no additive (closed circle), SCM/S-SBA-15 (open circle), SCM/S-α-TiO₂ (closed square), SCM/S-β-TiO₂ (open square) and SCM/S-γ-TiO₂ (closed triangle).

FIG. 13 Nyquist plot of full cells containing SCM/S-no additive (closed circle), SCM/S-α-TiO₂ (closed square), SCM/S-β-TiO₂ (open square) and SCM/S-γ-TiO₂ (closed triangle). Inset: Zoom-in of high frequency region to better identify SCM/S-α-TiO₂ (closed square) and SCM/S-β-TiO₂ (open square).

FIG. 14 Scanning electron microscope (SEM) images of (a) SCM/S before cycling; (b) SCM/S after 50 cycles; (c) SCM/S-α-TiO₂ before cycling and (d) SCM/S-α-TiO₂ after 50 cycles. Scale bar=5 nm.

FIG. 15 (a) FTIR spectra of neat α-TiO₂ (top); neat Li₂S₄ (middle) and neat α-TiO₂/Li₂S₄ (bottom); (b) Raman spectra of neat α-TiO₂ (top) and neat α-TiO₂/Li₂S₄ (bottom). Peaks characteristic of the material are highlighted with arrows.

### DETAILED DESCRIPTION OF THE INVENTION

A current producing cell as used herein refers to an electrochemical cell for producing a current including batteries and more particularly rechargeable batteries.

In an embodiment of the invention there is provided a solid electrode for use in an electric current producing cell or rechargeable battery. More particularly, the solid electrode is a sulfur cathode containing a conductive filler. During the electrochemical reactions of sulfur electrodes in a rechargeable battery, polysulfide ions are formed at intermediate voltages. These polysulfide ions are typically soluble in most organic or ionic liquid electrolytes.

One aspect of the invention relates to a method of retaining the dissolved polysulfide ions within the electrode. In a particular aspect the polysulfide ions are sorbed by a component of the electrode. As used herein the term “sorbed” or “sorption” is used to mean taken up and held, such as by absorption and/or adsorption, and may include being held in a reversible manner by weak binding. In another aspect of the invention the polysulfide ions are absorbed and/or adsorbed by the conductive component. In a further embodiment the absorption and/or adsorption is reversible.

In a further embodiment of the invention the sorption of the polysulfide ions and conduction of electrons to polysulfide ions are preformed by different components in the electrode. For example, these functions may be preformed by an insulating (or non-electroactive) component and an electrically conductive filler, respectively.

In a further embodiment of the invention the insulating or non-electroactive component has a porosity that is suitable for absorption of the polysulfide ions. In a particular embodiment the insulating component is a mesoporous material. In a further embodiment the mesoporous material has a porosity between 1 nm and 100 nm

A further embodiment of the invention provides a sulfur cathode for use in an electric current producing cell comprising:
(a) an electroactive sulfur-containing material;
(b) an electrically conductive filler and
(c) a non-electroactive component;
wherein the non-electroactive component is porous, and has one or more of:
   i) pore dimensions that permit absorption of a polysulfide anion and
   ii) active sites for polysulfide adsorption; and
wherein the absorption and/or adsorption is reversible.

In particular the aforementioned cathode is suited for use in a Li—S electric current producing cell.
(a) Electroactive Sulfur Containing Material

In an embodiment of the invention the electroactive sulfur-containing material comprises elemental sulfur or sulfur containing compounds. In a further embodiment a sulfur containing compound is a compound that releases polysulfide ions upon discharge or charge. In still a further embodiment the sulfur containing compound is a lithium-sulfur compound, such as, Li₂S.
(b) Electrically Conductive Filler

Electrically conductive fillers materials for use in solid electrodes are known in the art. Examples of such materials may include but are not limited to carbon black, carbon nanotubes, mesoporous carbons, activated carbons, polymer decorated carbons, carbons with surface rich in oxygen groups, graphite beads, metal powder, conducting oxide powder, conducting metal sulfide powder, conducting metal phosphide powder, and conducting polymers

In a particular embodiment, the electrically conductive filler is a carbon/sulfur nanocomposite. One example of a carbon/sulfur nanocomposite is mesoporous carbon that is imbibed with sulfur such as CMK-3/S. Silica colloidal monolith (SCM) is another type of mesoporous carbon which can be prepared from a commercial silica colloid, for example, LUDOX® HS-40 40% wt (available from Sigma Aldrich).

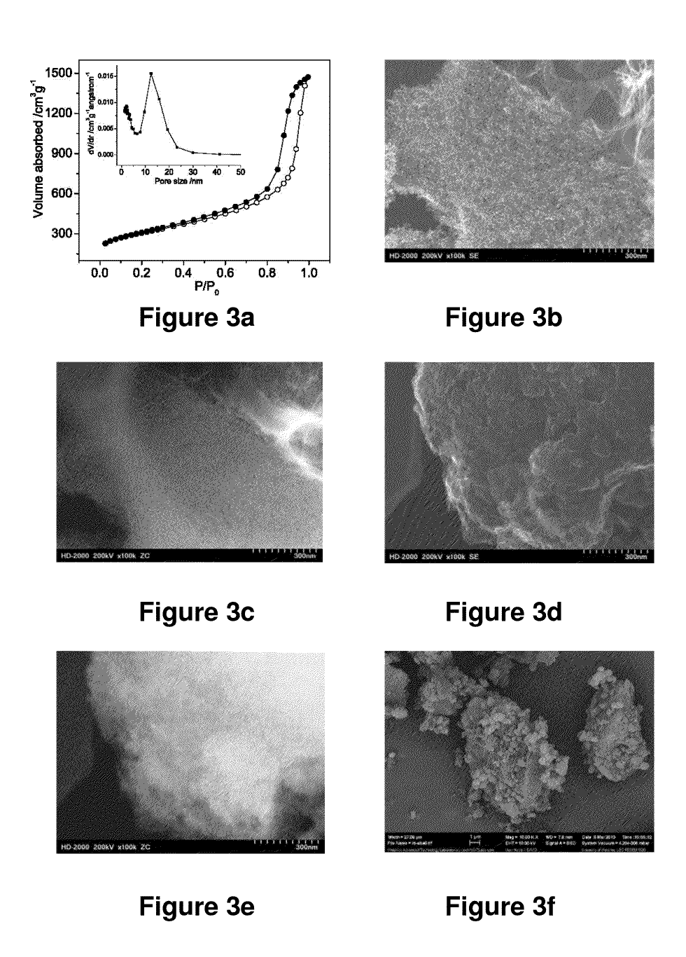

SCM exhibits a Brunauer-Emmett-Teller (BET) specific surface area of 1100 m2/g, and a narrow pore size distribution centered at 12.5 nm, as determined by the Barret-Joyner-Halenda (BJH) method (FIG. 3a). This carbon exhibits a very high specific pore volume of 2.3 cm³/g as shown in a representative high resolution scanning electron microscope (SEM) image of a fractured surface (FIG. 3b). The pores (˜12 nm in diameter) are distributed with no strict long range order, and are well inter-connected. The porous structure can also be observed in the dark field scanning transmission electron microscopy (STEM) image (FIG. 3c).

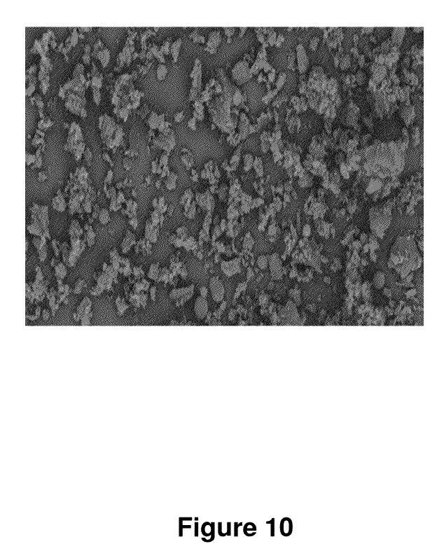

Use of SCM as the carbon framework for the sulfur electrode allows for control of the particle size, by varying the grinding force and duration of the carbon monolith. FIG. 10 shows an SEM image of a sample of SCM which exhibits an irregular morphology and an average particle size of ˜10 μm. The SCM/S electrode will exhibit a higher tap density than counterparts with smaller carbon particle sizes. The micron sized SCM/S structures still preserve the benefits of nano-dimensions due to their fine porous structure. As shown in FIG. 3d, the surface morphology of SCM is altered after the melt-diffusion process for sulfur impregnation. The corresponding STEM image shows much less porosity after sulfur filling, which is confirmed by pore volume measurements of the SCM/S composite that reveals a decrease from 2.3 to 0.31 cm³/g. The particle size of the SCM/S has benefits for electrode preparation as well. While electrode materials with decreased particle sizes have been developed, it has been shown that the superior performance of nanoparticles can come at the expense of necessity of binder overuse, lowered tap density, and potential safety concerns. The large particle size of SCM/S means that the amount of the polymer binder necessary to prepare electrodes is reduced to 5 wt % (vide infra) compared to the typical content of 20-28 wt % for electrode materials comprised of nanoparticles. Thus the composite exhibits the advantage of bulk sized electrode materials but with internal nanostructure.

In still a further embodiment the carbon monolith could be cast as a self-supporting electrode.

### (c) Non-Electroactive Component

It is a further aspect of the invention to provide a non-electroactive component for retaining the polysuphide ions at the electrode. The non-electrocactive component may also be termed an insulating component. These components are not active in conducting electrons. In a further embodiment, the term “non-electroactive” means that the components are of electrical conductivity of less than 1.0 Siemens/cm (S/cm). In a further embodiment the component are of electrical conductivity of less than 0.1 S/cm.

In an embodiment of the invention the non-electroactive component is an additive. In a further embodiment the non-electroactive component is present as a minor component of the cathode as a result of in-situ formation via the filler and is not added separately.

In an embodiment of the invention the component is a sorbent and/or agent with active sites for binding polysulfide ions. In a further embodiment the component is an absorbent material capable of absorption of polysulfide ions. In a further embodiment the absorption is reversible. In a further embodiment the material has active sites capable of adsorbing polysulphide ions. In still a further embodiment the adsorption is reversible. In a further embodiment of the invention the component is porous. In a further embodiment of the invention the pores have dimensions suitable for absorbing polysufide ions. In still a further embodiment the specific pore volume of the component is large. In yet further embodiment the components have a unit pore volume larger than, 0.1 cm³/g. In a further embodiment the component exhibits absorption capacity of the polysulfide ions to some degree. In a further embodiment said component is of a surface area larger than 10 m²/g. In a further embodiment said non-electroactive component has an average pore size in a range from 1 Å to 100 μm. In still a further embodiment the average particle size is 1 nm to 100 nm. In yet a further embodiment the component has an average particle size in a range from 1 nm to 100 μm.

In still a further embodiment the additive is of a contact angle with water droplet of less than 90°. The measurement of the contact angle with a water droplet provides an indication of the wetting properties of the component. The wetting properties define the hydrophilicity of the component.

In a further embodiment the non-electroactive component does not act as a current collector in the cathode during electrochemical reactions. This prevents reduction or oxidation of polysulfide ions from occurring within the pores of the component. Instead of extensively diffusing into electrolyte or further onto the anode, polysulfide ions which are dissolved in the cathode structure are kept in the pores of the cathode non-electroactive component during the operation of a battery.

The non-electroactive component may be used reversibly and in a long term manner due to the fact that solid active mass does not form in the pores of the non-electroactive component. The component may be in the form of an additive that is intimately mixed with the electrically conductive fillers. Alternatively, the component may be incorporated directly as a result of reaction of, or with the conductive filler. When the non-electroactive component and conductive materials are closely associated, as a result of in-situ formation or by mixing of the filler with an additive, the polysulfide ions are easily accessible to meet the needs of the electrochemical reaction. Further, this allows for efficient release of the ions as required for the electrochemical reaction to form solid electrode mass by transferring electrons between electrically conductive filler and polysulfide ions. It has been found that very little solid sulfide agglomeration forms on the carbon filler surface.

In a further aspect of the invention the polysulfide ions are sorbed by the non-electroactive component at the intermediate stages of charge of the electrochemical cell. At the stage of full discharge or charge the polysufide ions are desorbed from the additive. Therefore, the non-electoractive component contains less active mass when an cell is fully discharged or fully charged than when the electrochemical cell is in its intermediate stages of charge or discharge.

The non-electroactive component works in a highly reversible manner in its absorption of polysulfide ions. The reversible absorption and desorption of polysulfide anions is facilitated by the insulating properties of the component.

In one embodiment, the non-electoractive component is an additive and is selected from zeolites, supramolecular metal organic frameworks, carbon hydrates, cellulose, biomass, chitosan, nonmetallic metal oxides, metal sulphates, non-metallic metal nitrides, carbon nitrides, metal nitrates, non-metallic metal phosphides, metal phosphates, metal carbonates, non-metallic metal carbides, metal borides, metal borates, metal bromides, metal bromates, metal chlorides, metal chlorates, metal fluorides, metal iodides, non-metallic metal arsenides, metal hydroxides, molecular metal organic-ligand complexes and non-conducting polymers.

In another embodiment, the non-electroactive component is one of more of Si, Al, Ti, Ta, Nb, Ge, Ga, Sn, P, S as the oxide, nitride, oxynitride, carbide or sulfide.

In a further embodiment the additive is a mesoporous silica or transition metal silica or an insulating transition metal oxide having pore dimensions suitable for reversible absorption and/or adsorption of polysulfide ions. In a particular example, the additive is zeolite beta, molecular sieve 13X (Sigma-Aldrich), (MCM)-41 (Sigma-Aldrich) or (SBA)-15.

In still a further embodiment the non-electroactive component is porous silica that formed in-situ during preparation of the electrically conductive filler. For example the electrically conductive filler may be a conductive carbon which is prepared via filling a silica material with carbonaceous material, carburizing it and then removing the silica to leave behind the porous conductive carbon structure (into which the sulfur is imbibed). A small fraction of the porous silica material used in preparing the carbon structure may be retained and act as an in-situ non-electroactive component.

In another embodiment the additive is mesoporous titania. Mesoporous titania has been found to be more easily produced and less costly than SBA-15.

### Binding Compound

The electrode may further comprise a binding compound. Suitable binding compounds, or binders, will be known to a person of skill in the art and may include thermoplastic resins and rubbery polymers, for example, starch, polyvinyl alcohol, carboxymethyl cellulose, hydroxypropyl cellulose, regenerated cellulose, diacetyl cellulose, polyvinyl chloride, polyvinyl pyrrolidone, tetrafluoroethylene, polyvinylidene fluoride, polyethylene, polypropylene, ethylene-propylene-diene terpolymers (EPDM), sulfonated EPDM, styrene-butadiene rubbers, polybutadiene, fluorine rubbers, polyethylene oxide and the like. If using a compound having a functional group that is reactive with lithiuim, such as a polysaccharide, it is preferable to deactivate the functional group by addition of a compound having an isocyanate group. In an embodiment of the invention the binder may be used in an amount of 0.5-50% by weight, perferably 3 to 30% by weight based on total weight of the composition.

### Other Additives

In a further embodiment, the cathode may include other additives such as conductive carbon.

In a further aspect of the invention there is provided a rechargeable battery comprising:
a. an anode,
b. a separator,
c. a non-aqueous electrolyte and
d. a sulfur containing cathode comprising:
   (a) an electroactive sulfur containing material;
   (b) an electrically conductive filler and
   (c) a non-electroactive component;
      wherein the non-electroactive component is porous, and has one or more of:
      i) pore dimensions that permit absorption of a polysulfide anion and
      ii) active sites for polysulfide adsorption; and
      wherein the absorption and/or adsorption is reversible.

Various anodes for rechargeable batteries have been described in the art and would be known to a person of skill in the art. Sodium, lithium and magnesium have all been considered for use as anodes for rechargeable battery cells. Examples of suitable anode materials include, but are not limited to, metallic lithium; lithium metal protected with an ion conductive membrane or other coating; lithium alloys such as lithium-aluminum alloy or lithium-tin alloy; silicon containing anodes or silicon lithium containing anodes; lithium intercalated carbons; lithium intercalated graphites; sodium, sodium alloys, magnesium and magnesium alloys. The anode may further include electrically conductive filler materials (as defined above) and/or binders (as defined above).

In an embodiment of the invention the non-aqueous electrolyte may be a liquid, a solid or a gel. In one embodiment, the electrolyte is liquid. In a further embodiment the non-aqueous electrolyte is a solution comprising at least one organic solvent and at least one salt soluble in the solvent.

Suitable organic solvents include aprotic solvents, e.g. propylene carbonate, ethylene carbonate, butylene carbonate, dimethyl carbonate, diethyl carbonate, y-butyrolactone, 1,2-dimethoxyethane, tetrahydrofuran, 2-methyltetrahydrofuran, dimethyl sulfoxide, 1,3-dioxolane, formamide, dimethylformamide, dioxolane, acetonitrile, nitromethane, methyl formate, methyl acetate, methyl propionate, ethyl propionate, phosphoric triesters, trimethoxymethane, dioxolane derivatives, sulfolane, 3-methyl-2-oxazolidionone, propylene carbonate derivatives, tetrahydrofuran derivatives, ethyl ether, and 1,3-propanesultone. These solvents may be used either individually or in combination of two or more thereof. In a particular embodiment the solvent is a polar organic solvent.

Suitable lithium salts soluble in the above solvents include LiClO₄, LiBF₆, LiPF₆, LiCF₃SO₃, LiCF₃CO₂, LiAsF₆, LiSbF₆, LiB₁₀Cl₁₀, lower aliphatic lithium carboxylates, LiAlCl₄, LiCl, LiBr, LiI, chloroboron lithium, and lithium tetraphenylborate. These lithium salts may be used either individually or in combination of two or more thereof.

Other suitable salts and or ionic liquids would be known to a person of skill in the art and may be included in the non-aqueous electrolyte.

In particular, a solution of LiCF₃SO₃, LiClO₄, LiBF₄ and/or LiPF₆ in a mixed solvent of propylene carbonate or ethylene carbonate and 1,2-dimethoxyethane and/or diethyl carbonate is a preferred electrolytic solution. The amount of the electrolytic solution to be used in a battery may be varied over a wide range and would be known to person of skill in the art.

The concentration of the supporting electrolyte is preferably from 0.2 to 3 moles per liter of the electrolytic solution.

In addition to electrolytic solutions, inorganic or organic solid electrolytes may also be employed. Examples of suitable inorganic solid electrolytes include lithium nitrides, lithium halides, and lithium oxyacid salts. Among them preferred are Li₃N, LiI, Li₅NI₂, Li₃N—LiI—LiOH, LiSiO₄, LiSiO₉—LiL—LiOH, xLi₃PO₉—(1-x)Li₉SiO₄, LiSiS₃, and phosphorous sulfide compounds. Examples of suitable organic solid electrolytes include polyethylene oxide derivatives or polymers containing ethylene oxide, polypropylene oxide derivatives or polymers containing propylene oxide, polymers containing an ionizing group, a mixture of a polymer containing an ionizing group and the above-mentioned aprotic electrolytic solution, and phosphoric ester polymers. Combinations of polyacrylonitrile and an electrolytic solution and of an organic solid electrolyte and an inorganic solid electrolyte may also be used in the present invention.

In an embodiment of the invention, a separator is a barrier between the anode and the cathode. It is known in the art that the separator is generally a porous material which separates or insulates the anode and cathode from each other. Various separators have been developed and used and would be known to one of skill in the art. Examples of materials which can be used as the porous layer or separator include polyolefins such as polyethylenes and polypropylenes, glass fiber filter papers and ceramics materials and the like. The separator materials may be supplied as porous free standing films which are interleaved with the anodes and the cathodes in the fabrication of electric current producing cells. Alternatively, the porous layer can be applied directly to one of the electrodes.

Other features of the invention will become apparent in the course of the following description of the exemplary embodiments which are given for the purpose of illustration of the invention and are not intended to be limiting thereof.

While the following examples describe a lithium sulfur electric current producing cell it will be understood that the sulfur cathode may also be used in other current producing cells such as sodium sulfur and magnesium sulfur cells.

### EXAMPLES

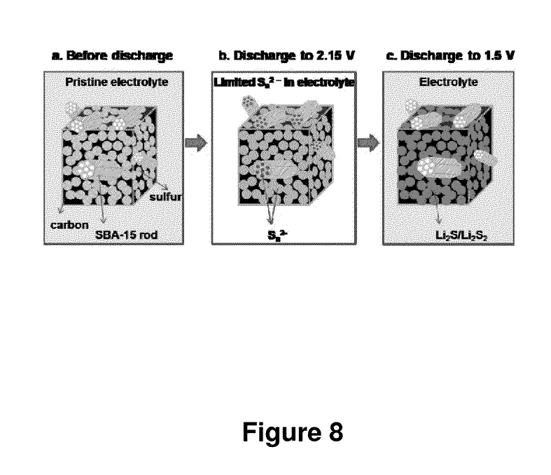

In a particular example an electrode comprising SCM/S and SBA-15 was prepared. The function of the polysulfide reservoirs is illustrated conceptually in FIG. 8. To homogeneously incorporate the SBA-15 platelets (10 wt %) within the SCM/S (90 wt %), the solids were well dispersed and mixed by sonication. The silica platelets are incorporated within the aggregated particles by the mixing process; they are also visible on the surface as shown in the SEM image in FIG. 3f. Their characteristic shape makes them easy to identify which is important for the Energy dispersive X-ray Spectroscopy (EDX) studies that verify the sulfur reservoir concept (vide infra). The electrical conductivity of the electrode materials both with and without the SBA-15 additive was the same, ˜6 S/cm, showing that the silica has no effect owing to its low overall concentration.

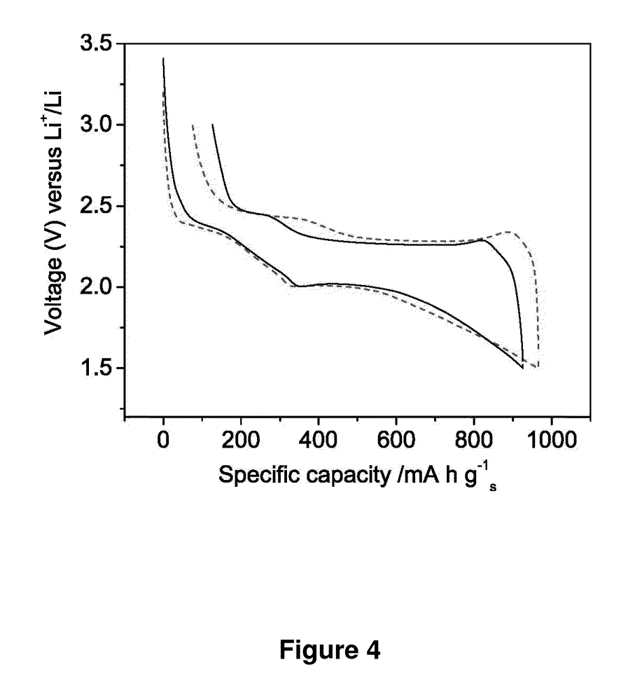

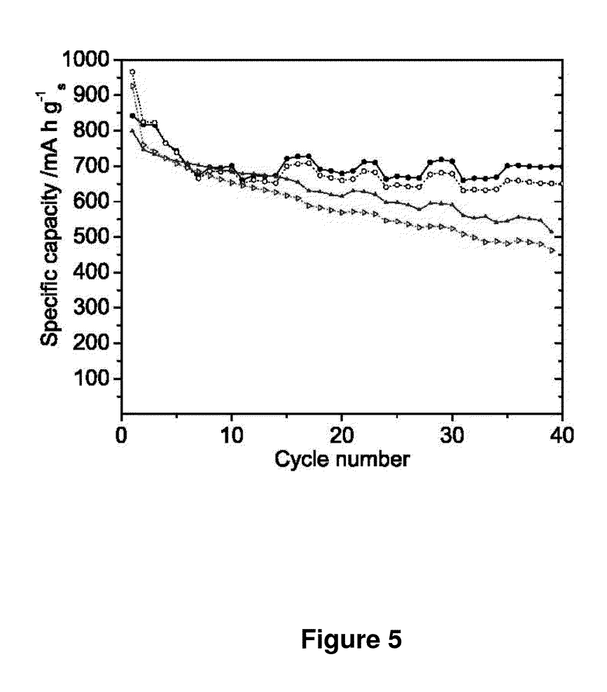

Electrochemical measurements of SCM/S electrodes were carried out to investigate the influence of the SBA-15 incorporation. FIG. 4 shows the galvanostatic discharge/charge profiles recorded at a current rate of C/5 (334 mA/g or 0.4 mA/cm2). The initial discharge capacity of the cell with SBA-15 is 960 mA·h/g, where the mass (g) refers to the active sulfur component, following convention. This is greater than the capacity of 920 mA·h/g exhibited by the cell without SBA-15. Both cells exhibit some irreversible capacity in the first cycle, and it is less with the SBA-15 additive although slightly higher polarization is observed. Overall, the presence of SBA-15 in the sulfur electrode greatly improves the overall electrochemical performance. As FIG. 5 shows, without SBA-15, the cell suffers both capacity fading and an increasing divergence between the charge and discharge capacity as a result of the polysulfide shuttle mechanism. The large pore size of SCM carbon is expected to permit significantly more polysulfide dissolution than CMK-3.

With the addition of SBA-15, as FIG. 5 (circles) illustrates, although the cell experiences some initial capacity fading (˜30%), from the 10th cycle onward this is almost completely curtailed. A discharge capacity well above 650 mA·h/g is steadily maintained beyond 40 cycles.

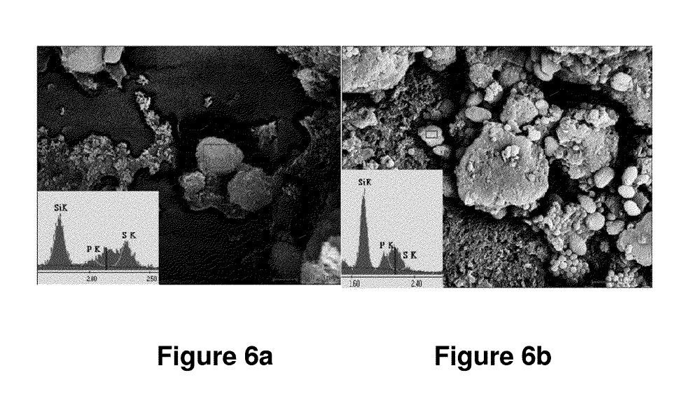

Energy Dispersive X-ray spectroscopy (EDX) was used to investigate whether electrochemically generated polysulfide anions are absorbed by SBA-15 platelets and desorbed when necessary, i.e., near the end of discharge. Tetraethylene glycol dimethyl ether (TEGDME) was employed as the electrolyte solvent containing 1M LiPF6 for this EDX study and for the analysis of the sulfur concentration in the electrolyte. Because the concentration of LiPF6 should be a constant value within the SBA-15 particles in the sulfur electrode throughout cycling, the phosphorus signal acts as an internal reference via determination of the S/P ratio. To determine the absorption capacity of SBA-15 additive for polysulfide anions, the electrode material was extracted (in an Ar filled glovebox) from a cell which was discharged to 2.15 V in its 40th cycle at a current rate of C/5 (334 mA/g or 0.4 mA/cm2). At this potential, elemental sulfur is completely converted to soluble polysulfide species, i.e., S62−·2Li+. The cathode was investigated by SEM and EDX. As shown in FIG. 6a, EDX signals collected from an SBA-15 particle show a very high sulfur/phosphorus (S/P) atomic ratio of 3.4 averaged from 20 spots. Therefore, one can expect that the polysulfide anion concentration in the electrolyte will be much lower in the presence of SBA-15 in the cathode layer, as schematically shown in FIG. 8b. This will greatly hinder the redox shuttle in the electrolyte and in turn prevent active mass loss on both electrodes.

To determine whether the absorbed polysulfide can be desorbed on demand, electrode material was obtained from another cell which was discharged to 1.5 V at the end of the 40th discharge. A much lower average S/P ratio of 0.2 in the SBA-15 was measured (30 spots), as shown in FIG. 6b. By comparing the S/P ratio at 2.15 V and 1.5 V, it is estimated that ˜94% of the sulfur mass in the SBA-15 particles was desorbed and participated in electrochemical reactions even during the 40th cycle. A glassy sulfide agglomeration phase on the cathode surface was not observed (FIG. 6). Due to the fact that the SBA-15 polysulfide nanoreservoirs also reside on the surface of SCM/S particles in addition to being contained within the bulk, polysulfide ions can easily diffuse back within the pores of SCM instead of being reduced on the surface to form agglomerates. Therefore, much less polysulfide will diffuse into the electrolyte with the addition of SBA-15, as schematically shown in FIG. 8b. The reversible absorption and desorption of polysulfide anions is also facilitated by the insulating properties of the silica. If the absorbent is electrically conductive, it is believed that sulfide agglomeration will rapidly occur on the surface of the absorbent.

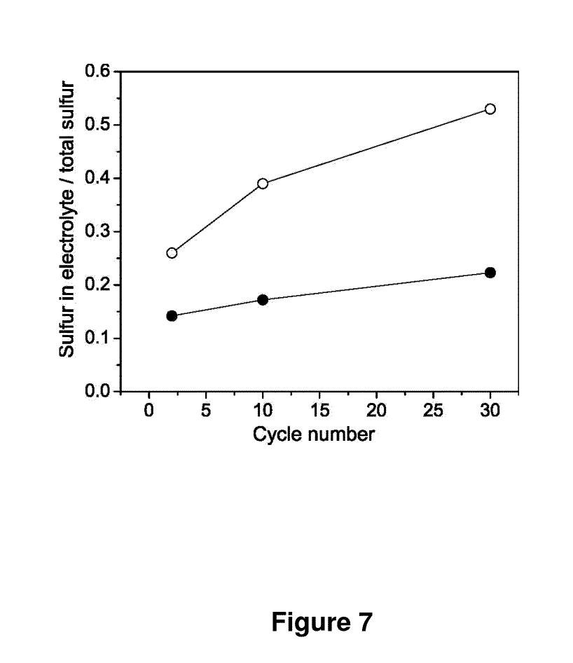

The sulfur electrolyte concentration was measured in the cells with and without the SBA-15 additive in this large-pore carbonaceous electrode. Less than 23% of sulfur is found in the electrolyte at the 30th cycle in the former case, and 54% of sulfur for the latter case, as shown in FIG. 7. This result confirms the electrochemical results.

### Example A

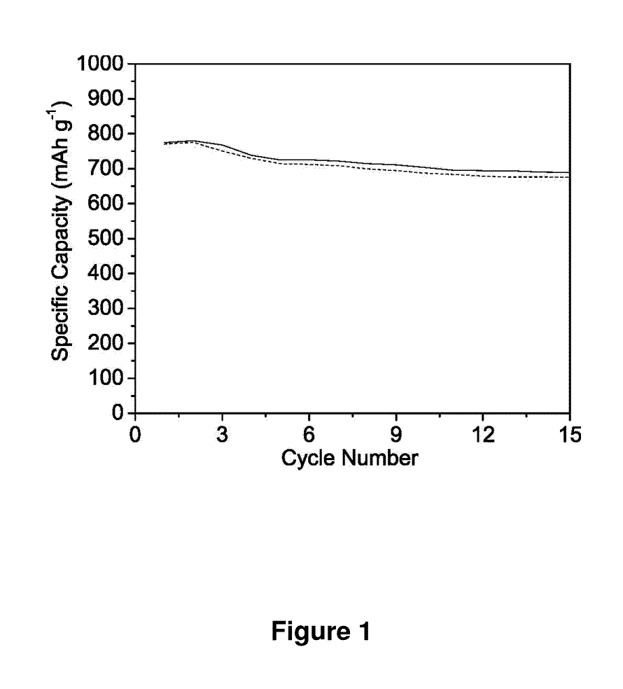

In Example A 0.1 g of molecular sieve 13X (Sigma-Aldrich), a zeolite, 0.2 g of Ketjen Black, 0.6 g of elemental sulfur (Sigma-Aldrich) and 0.1 g of polyvinylidene fluoride (PVDF) were mixed and ground in acetone. The cathode materials were slurry-cast onto a carbon-coated aluminum current collector (Intelicoat). The electrolyte is composed of a 1.2M LiPF6 solution in ethyl methyl sulphone. Lithium metal foil was used as the counter electrode. Electrochemical measurements of electrodes were carried out on an Arbin System. FIG.1 shows the stabilizing effect of zeolite on cyling performance of sulfur cathode. The cell was cycled at a current rate of 334 mA/g or ˜C/3 (a full sweep completed in ˜3 hours). The coulombic efficiency was kept above 95% in the first 15 cycles. This proves the effectiveness of this zeolite additive.

### Example B

Mesoporous silica, SBA-15, was used as an additive and a mesoporous carbon called SCM with an average pore size more than 10 nm is employed as the electrically conductive filler.

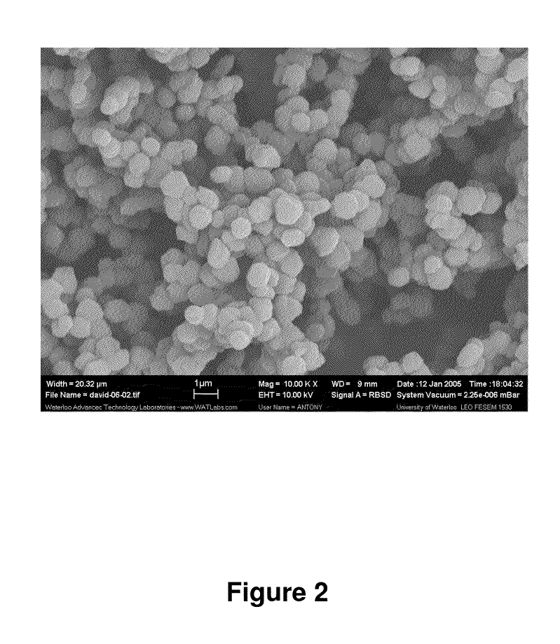

SBA-15 is a well developed mesoporous silica which exhibits high surface area, large pore volume, bi-connected porous structure, and highly hydrophilic surface properties. The morphology of SBA-15 is shown in its scanning electron microscopy (SEM) image (FIG. 2).

### Preparation of SCM is as Follows:

Silica colloid (LUDOX® HS-40 40wt %, Sigma-Aldrich) 5 g was dried in a petri-dish and formed an semi-transparent silica monolith template (2 g) which was impregnated for 10 min with an isopropyl alcohol solution (5 ml) containing oxalic acid (97% Fluka), 80 mg as a catalyst for polymerization of carbon precursors. Isopropyl alcohol was later evaporated in an oven at 85 ° C. Later on the oxalic acid loaded silica monolith was impregnated in a mixture of rescorcinol (98%, Sigma-Aldrich) 2 g and crotonaldehyde (98% Sigma-Aldrich) 1.7 g for 1 hr. Filtration was applied to the soaked silica monolith to remove excessive part precursors. The mixture was then subjected to polymerization through a series of heat treatment in air under the following conditions: 60° C. for 30 min, 120° C. for 10 hrs, 200° C. for 5 hrs. The obtained polymer was carbonized at 900° C. in an argon atmosphere. The silica/carbon composite monolith was ground into powder before the silica template was removed by HF (15%) etching.

In example B, 0.1 g SBA-15, 0.2 g SCM carbon, 0.65 g elemental sulfur and 0.05 g PVDF were mixed and ground in acetone. The cathode materials were slurry cast onto a carbon-coated aluminum current collector. The electrical conductivity for both electrode materials with and without SBA-15 additive is the same ˜6 S/cm, which is most likely due to the homogeneity of SBA-15 rods in the electrode material. FIG. 3 demonstrates the attachment of SBA-15 rods on the surface of larger particles of SCM/S.

FIG. 4 shows the first galvanostatic discharge/charge profiles recorded at a current rate of 334 mA/g or ˜C/3. The solid line is from the cell without SBA-15 additive. The dashed line is from the cell with SBA-15 additive. The first discharge capacity of the cell with SBA-15 is 960 mA·h g−1, larger than 920 mA·h g−1 exhibited by the cell without SBA-15.

As FIG. 5 shows, although the cell experiences some capacity fading in the first 10 cycles, from 10th cycle on, there is almost no capacity fading with the addition of SBA-15. Discharge capacity above 650 mA h·g−1 is maintained after 40 cycles. Importantly, coulombic efficiency is maintained at nearly 100% for 30 cycles, which indicates the absence of polysulfide shuttles in the cell. Energy dispersive X-ray Spectrum (EDX) was used to investigate whether electrochemically generated polysulfide anions are absorbed by SBA-15 rods and desorbed when necessary, i.e., near the end of discharge. Tetraethylene glycol dimethyl ether (TEGDME) was employed as the electrolyte solvent (containing 1M LiPF6) in the cells for this EDX study and sulfur concentration analysis in the electrolyte. The concentration of LiPF6 is a constant value inside all SBA-15 particles in the electrode, throughout cycling. Therefore, phosphorus EDX signal was used as a standard to evaluate the concentration of sulfur absorbed in SBA-15 particles.

To determine the adsorption capacity of SBA-15 additive on polysulfide anions, a cell was discharged at a current rate of C/2 to 2.15 V at its 40th cycle where elemental sulfur is mostly converted to soluble polysulfide species, i. e., S6 2−·2Li+. The composite cathode was investigated by SEM and EDX. As shown in FIG. 6a, EDX results collected from a SBA-15 rod marked by the square, show a high sulfur/phosphorus (S/P) atomic ratio (average at 3.4). On the other hand, to learn whether the absorbed polysulfide can be desorbed when necessary, the P/S ratio which is quite low (average at 0.2) was obtained from SBA-15 rods in the electrode at 1.5 V, the end of its 40^{th} discharge, as shown in FIG. 6b. By comparing the S/P ratio at 2.15 V and 1.5 V, it is clear that 94% of sulfur in SBA-15 was desorbed and participates in electrochemical reactions even after 40 cycles.

Superior to oxide nanoparticles which may absorb polysulfide anions within the vicinity probably by forming a thin ion layer, mesoporous silica particles are able to provide not only the strong adsorption but also accommodation space for diffused polysulfide anions. Therefore, fewer polysulfide anions will diffuse into electrolyte with the addition of SBA-15. This will greatly hinder the polysulfide shuttle and the other deleterious effects of deposition of the sulfide deposits on the electrode surfaces and the loss of active mass from the cathode. The reversible absorption and desorption of polysulfide anions is facilitated by the insulating properties of silica. If the absorbent is electrically conductive, sulfide agglomeration may rapidly form on the surface of absorbent.

The sulfur concentration of electrolyte for the cells with and without SBA-15 additive was measured. Less than 23% of sulfur is found in electrolyte at 30th cycle in the former case, and 54% of sulfur for the latter case, as shown in FIG. 7. This result confirms the electrochemical results of materials.

### Example C

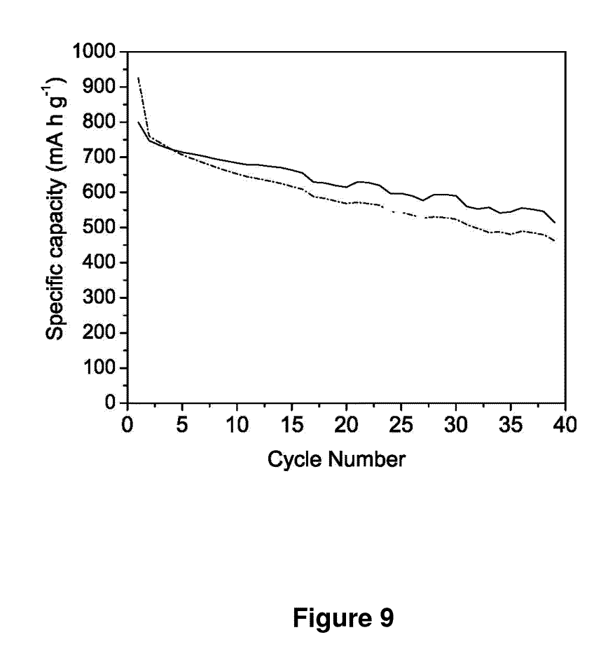

In this example, a cathode not containing a non-electroactive component was prepared. In the preparation of the cathode, 0.2 g SCM carbon, 0.65 g elemental sulfur and 0.05 g PVDF were mixed and ground in acetone. The cathode materials were slurry cast onto a carbon-coated aluminum current collector. FIG. 4 (solid line) shows the first galvanostatic discharge/charge profiles recorded at a current rate of 334 mA/g or ˜C/3. The first discharge capacity of the cell without SBA-15 is 920 mA·h g−1. Both cells in Example B and C exhibit irreversible capacity in the first cycle, and the case with SBA-15 additive is less. It is noticeable that polarization of the cell with SBA-15 is slightly larger than the one without SBA-15 probably due to lowered electronic conductivity; however, it is evident that the presence of SBA-15 in the sulfur electrode helps improve the overall electrochemical performances. Without SBA-15, the cell in Example C suffers both quick capacity fading and an increasing divergence between charge and discharge capacity as shown by FIG. 9. This may be due to the large pore size of SCM carbon, which allows easy polysulfide dissolution at a slow rate and facilitates the polysulfide shuttles.

### Example D

In yet another example, mesoporous titania was used as the non-electroactive component. Titania is known to be more electropositive than silica, it is therefore, expected to have greater absorption capacity than mesoporous silica. Additionally, an increase in the electrostatic attraction between negative polysulfides and the oxide surface may result.

To clarify the nature of the adsorption and/or absorption mechanism and quantify the improvement in the electrochemical performance, three different morphologies of TiO₂ with different physical properties (surface area, pore volume and pore size) were tested. These different morphologies of mesoporous titania were used as additives to a cathode comprised of sulfur imbibed in a large-pore mesoporous carbon (SCM, >10 nm) where LiPS dissolution is more pronounced.

The synthesis of SCM was performed according to the procedure described above. The titania and silica additives were mixed with the SCM in aqueous medium before melt-infiltration of the sulfur. The resulting composites featured a mesoporous carbon that accommodates ˜60 wt % sulfur in its pores in intimate contact with the additive. It is noteworthy that only ˜3 wt % (total cathode material) additive was used in these studies.

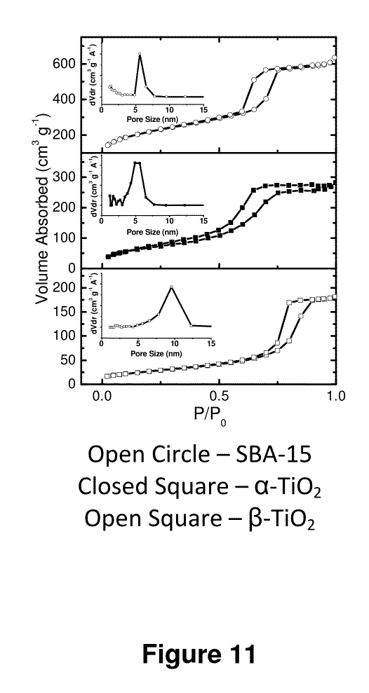

The nitrogen BET isotherms for SBA-15 and the three morphologies of TiO₂ are shown in FIG. 11. The BET analysis of SBA-15 (FIG. 11) shows that it has a very high surface area (918 m²/g) and pore volume (1.00 cc/g) with a very narrow pore size distribution centered at 5.6 nm. The hysteresis in the BET isotherm is indicative of a strong capillary force in the mesopores of SBA-15 for N₂ adsorption. In the titania samples, α-TiO₂ exhibited a similar isotherm to SBA-15 with a pore size distribution centred at 5.2 nm. One difference is that α-TiO₂ has a significantly lower specific surface area (275 m²/g) and pore volume (0.41 cc/g) compared to SBA-15 as evidenced by the decreased nitrogen uptake. (3-TiO₂ was synthesized to target larger pores (9.6 nm) than α-TiO₂ in order to identify if polysulfide absorption was a function of pore size. To isolate this possible effect, the specific surface area and pore volume were kept similar between α and β-TiO₂. The third titania material, nanocrystalline γ-TiO₂ was examined to determine if the surface properties of the oxide were more important than pore absorption. The γ-TiO₂ is a non-porous titania with a similar surface area to both α and β-TiO₂. Based on these comparisons, it can be determined if the LiPS interact with titania through purely adsorption, absorption or a combination of the two.

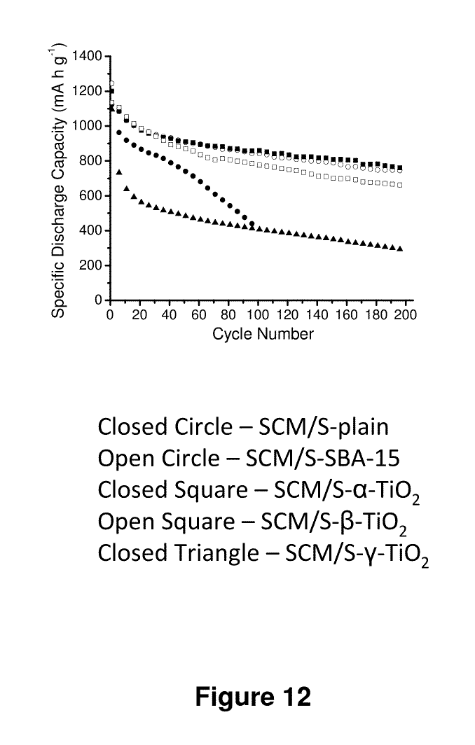

The electrochemical results of the four additives in Li—S cells are compared in FIG. 12. A large pore carbon (12 nm) termed SCM was infused with about 70wt % sulfur, and the different additives were added to form a cathode composite. The cathodes were examined in a coin cell configuration using 1M LiTFSI in a mixed solvent of 1,3-dioxolane and 1,2-dimethoxyethane (1:1 vol %) as the electrolyte. Li foil was used as the counter electrode. The batteries were cycled between 1.5 V and 3 V using a high current rate of 1C (1675 mA g⁻¹, full discharge in 1 hour). Voltage profiles of the tenth discharge of each cell are shown in FIG. 12a. This data more clearly highlights the discharge characteristics since the cell has undergone a few conditioning cycles. The voltage profile for each material is indicative of a typical Li—S cell with two voltage plateaus (˜2.4 V and ˜2.0 V) corresponding to reduction of sulfur from high order LiPS to lower order LiPS. The long term cycling of the cells is shown in FIG. 12b with 100 cycles shown for the SCM/S cathode (no additive) and 200 cycles for the SCM/S-additive cathodes. It is readily apparent that the addition of any of SBA-15, x-TiO₂, or β-TiO₂ can dramatically increase the performance of the SCM/S cathode. The first discharge capacities and specific capacity retention of each material are shown in Table 1.

TABLE 1
First discharge capacity of each cathode material and the percentage
of discharge capacity retained in each cathode after 100 and
200 cycles in comparison to the tenth cycle capacity

| | | SCM/S- | SCM/S-α- | SCM/S-β- | SCM/S-γ- |
|---|---|---|---|---|---|
| | SCM/S | SBA-15 | TiO₂ | TiO₂ | TIO₂ |
| 1^{st} cycle | 1123 | 1244 | 1201 | 1135 | 1094 |
| C₁₀₀/C₁₀ | 45 | 81 | 82 | 74 | 63 |
| C₂₀₀/C₁₀ | — | 71 | 73 | 62 | 44 |

SBA-15 and α-TiO₂ exhibit almost identical cycling stability and high initial discharge capacities above 1200 mA h g⁻¹ (>71% sulfur utilization). Even though the surface area and pore volume of α-TiO₂ is significantly less than SBA-15, the overall diminution of LiPS dissolution is the same, as evident from the cycling stability which is almost identical. The overall effect of β-TiO₂ on cycling stability is slightly less than α-TiO₂ and SBA-15. The larger pore size of β-TiO₂ (9.6 vs˜5.2 nm) leads to poorer absorption properties compared to that of the smaller pores and hence reduced effectiveness at retaining LiPS. The most surprising result is that of the cathode with the γ-TiO₂ additive, which showed very poor cycling stability even compared to SCM/S. This suggests that surface adsorption of polysulfide ions is not singularly effective at increasing cycling stability because the surface area is very similar between the porous and non-porous titanias. The electrochemical results clearly show that LiPS predominantly interact with titania through an absorption mechanism.

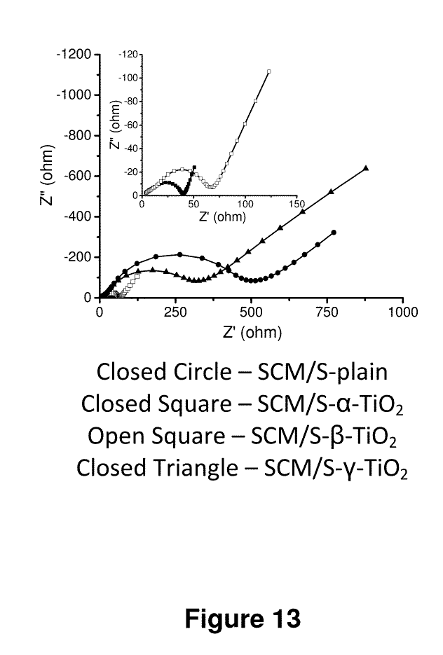

The stability from the porous titania additives is apparent and readily explained. However, there was also a significant decrease in discharge capacity of the SCM/S-γ-TiO₂ cathode material. In order to have a comparable surface area between the non-porous and porous titania, the particle size had to be very small. In this case, γ-TiO₂ exhibits a particle size between 4-6 nm and a specific surface area of 190 m²/g. The porous titanias are significantly larger on the order of a few microns. Impedance studies were performed on full cells of each cathode material with the different additives and the Nyquist plots are shown in FIG. 13. The very high frequency impedance is similar for each material, which is expected since this impedance is a measure of bulk electrolyte resistance in the cell. The high frequency (HF) semi-circle is the most noticeable difference between each material. M. Holzapfel, A. Martinent, F. Alloin, B. Le Gorrec, R. Yazami and C. Montella, J. Electroanal. Chem., 546, 41 (2003) have postulated that this is due to poor contact between particles in the electrode as opposed to a passivation layer. Since these impedance data were gathered at open circuit voltage (˜2.8-3.0 V), the electrolyte is stable and should not form a solid electrolyte interface. The reference material is the SCM/S cathode as it is comprised only of sulfur and carbon. Both the SCM/S-α-TiO₂ and SCM/S-β-TiO₂ exhibit a significantly smaller HF semi-circle than SCM/S alone. This seems to be counter-intuitive since titania is an insulator and should decrease the electrical contact between SCM/S particles. However, micron sized titania as an additive has been shown to decrease charge transfer resistance in MnO₂ electrodes and interacts favourably at the junction of MnO₂/electrolyte/carbon to increase charge transfer (M. Bailey and S. Donne, J. Electrochem. Soc., 158, A802 (2011)). Interestingly, when γ-TiO₂ is added to the cathode the HF semi-circle is greatly increased when compared to the other additives and is even larger than the SCM/S-plain cathode. This is explained by the greater number of γ-TiO₂ particles in the SCM/S matrix due to their nanoscale particle size which will increase the charge transfer resistance between the SCM/S particles. The lowering of the charge transfer resistance is also observed in the voltage profiles of each material (FIG. 12a) by a decrease in over potential. Cathodes containing either α or β-TiO₂ additives exhibit an increase in discharge potential of 0.075V at a capacity of 600 mAh/g vs that of the SCM/S cathode alone.

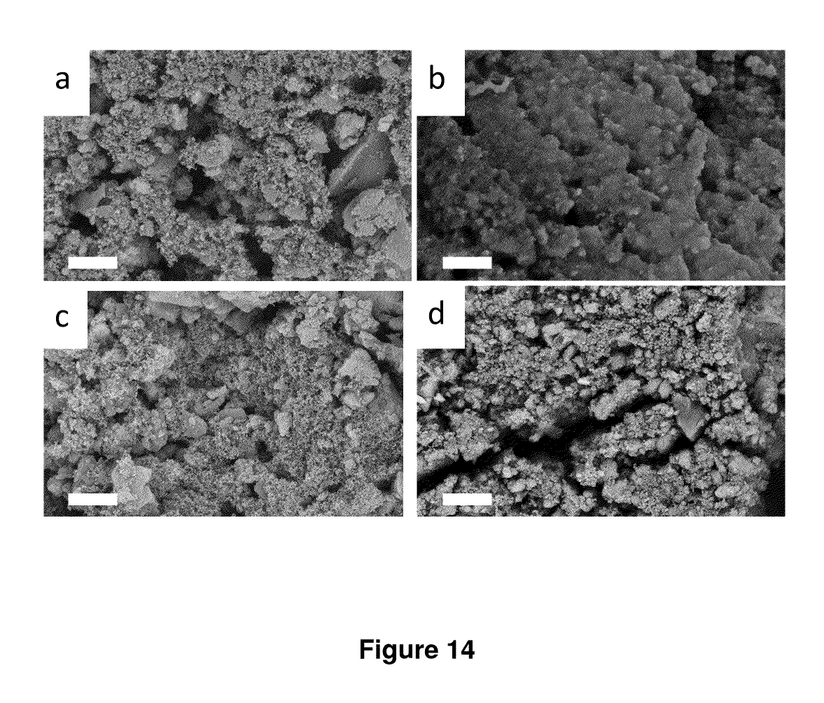

In order to verify that mesoporous TiO₂ prevents polysulfide dissolution during the electrochemical process, the electrode material from a cell containing no titania additive was compared to a cell containing α-TiO₂. SEM images of the two cathode materials are shown in FIG. 14. Each cell was cycled for 50 cycles and the material was collected at the end of discharge at 1.5 V. The pristine, non-cycled SCM/S-plain and SCM/S-α-TiO₂ are very similar (FIGS. 14a and 14c). However, upon cycling the SCM/S cathode, it is readily apparent that low order glassy LiPS (Li₂S₂ and Li₂S) are formed on the exterior of the carbon particles. Without wishing to be bound by theory, it is believed these are responsible for the rapidly fading discharge capacity over 100 cycles seen in FIG. 12. When the α-TiO₂ is added to SCM/S a drastic change in the surface morphology is observed. SEM micrographs reveal no glassy Li₂S phase on the surface of the material after 50 cycles. This is indicative of the ability of a polysulfide absorbent such as mesoporous TiO₂ to effectively trap polysulfides at the cathode and also not allow them to build up in high concentrations outside of the carbon cathode where they can reduce and form an undesirable insulating coating.

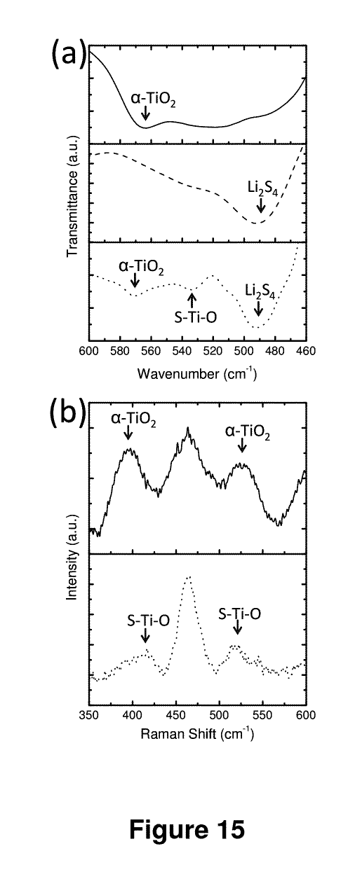

In order to clarify whether titania interacts with LiPS through absorption due to the porous architecture or via physical/chemical adsorption, the bonding interaction between titania and sulphur was probed using FTIR and Raman spectroscopy (FIG. 15). LiPS were synthesized following a previously reported method where sulfur is reduced by lithium triethylborohydride (LiEt₃BH) in tetrahydrofuran. Sulfur and LiEt₃BH were reacted in a molar ratio of 2:1, in order to form intermediate length LiPS that are targeted at a stoichiometry of Li₂S₄. This synthesis was performed with and without α-TiO₂ present in order to probe the interaction between reduced sulfur species and titanium. In FIG. 15a FTIR spectra of neat LiPS and neat α-TiO₂ are compared to α-TiO₂ in the presence of LiPS. The LiPS showed a characteristic S—S band (492 cm⁻¹) and α-TiO₂ displayed a Ti—O band (571 cm⁻¹). In the third spectrum—where LiPS was synthesized in the presence of α-TiO₂—a new band appeared at 534 cm⁻¹. While not wishing to be bound by this theory, it is thought that this band is due to an interaction between sulfur and titania (S—Ti—O) that can be considered as adsorption of LiPS on the surface of α-TiO₂. The Raman spectra of α-TiO₂ and α-TiO₂/LiPS also highlight the sulfur—titania interaction. Two peaks at ˜415 cm⁻¹ and ˜545 cm⁻¹ in the neat α-TiO₂ shift to ˜430 cm⁻¹ and ˜535 cm⁻¹ when LiPS is added to the system.

This peak shift shows that the environment around the surface titanium atoms is altered in the presence of LiPS. Therefore, enhancement of the electrochemical properties of SCM/S by α-TiO₂ can be explained as a cooperative tandem between weak adsorption on the surface and absorption by the pores that together inhibit the loss of polysulfides into the electrolyte.

Coupling of mesoporous titania additives to a sulfur/carbon composite improves the cycle life and capacity retention of the Li—S battery. This approach circumvents the need to apply coatings to the carbon in order to prevent or lessen polysulfide dissolution which can hinder the rate characteristics of the cell. The use of mesoporous titania particles mixed with the carbon/sulfur particles allows cycling at high C rates while maintaining discharge capacities above 750 mA h g⁻¹ after 200 cycles. The effect of mesoporous titania addition is significant and is achieved with only ˜3 wt % additive.

Preparation of SCM: SCM was synthesized according to the method described above.

Preparation of β-TiO₂: For the synthesis of β-TiO₂ with controlled morphology, 1 g of Pluronic P123 (EO₂₀PPO₇₀EO₂₀) was dissolved in 10 g of EtOH at 40° C. Titanium tetrachloride (1.1 ml) was added to the above solution with vigorous stirring. The mixture was stirred for 30 min and the resulting sol solution was dried in an open Petri dish at 40° C. in air for 7 days. The as-made bulk samples were collected and calcined at 400° C. for 5 h in air.

Preparation of SBA-15: SBA-15 was synthesized according to the method described by C. Yu et al., in Chem. Mater., 16, 889 (2004), hereby incorporated by reference.

Preparation of SCM/β-TiO₂ and SBA-15 composite: A mixture of SCM (50 mg) and β-TiO₂ (5 mg) or SBA-15 (5 mg) or Ti-SBA-15 (5 mg) was dispersed in water (5 ml), and sonicated for 1 h and then stirred for 4 hrs. The water was evaporated in a 130° C. oven for 48 h, and the material was dried in a vacuum oven at 100° C. overnight to remove any residual water.

Preparation of SCM/(β-TiO₂ or SBA-15)/60S composite: SCM/β-TiO₂ (40 mg) was ground with sulfur (60 mg) and heated to 155° C.

Electrochemical measurement: Positive electrodes were constructed from SCM/(β-TiO₂ or SBA-15 or Ti-SBA-15)/605 (80 wt %), poly(vinylidene difluoride) (PVdF) binder (10 wt %), Super S (10 wt %). The cathode material, ready for electrochemical studies, contained 48 wt % of sulfur as active mass and 3.6 wt % additive (β-TiO₂ or SBA-15). The cathode material was well dispersed in cyclopentanone by sonication and slurry-cast onto a carbon-coated aluminum current collector (Intelicoat), and 2025 coin cells were constructed using an electrolyte composed of a 1.0 M LiTFSI (lithium bis(trifluoromethanesulfonyl) imide) solution in DOL (1,3-dioxolane) and DME (1,2-dimethoxyethane) (1:1 volume ratio). Lithium metal foil was used as the anode. In the comparison study with SCM/S, the SCM/S electrode was also mixed with 10 wt % of PVdF and 10 wt % of Super S.

Characterization: Nitrogen adsorption and desorption isotherms were obtained using a Quantachrome Autosorb-1 system at −196° C. Before measurement, the sample was degassed at 150° C. on a vacuum line following a standard protocol. The BET method was used to calculate the surface area. The total pore volumes were calculated from the amount adsorbed at a relative pressure of 0.99. The pore size distributions were calculated by means of the Barrett-Joyner-Halenda method applied to the desorption branch. The morphology of the mesoporous metal oxides were examined by a LEO 1530 field-emission SEM instrument. FTIR, Raman, TGA.

Although the invention has been described with reference to certain specific embodiments, various modifications thereof will be apparent to those skilled in the art without departing from the purpose and scope of the invention as outlined in the claims appended hereto. Any examples provided herein are included solely for the purpose of illustrating the invention and are not intended to limit the invention in any way. Any drawings provided herein are solely for the purpose of illustrating various aspects of the invention and are not intended to be drawn to scale or to limit the invention in any way.

The disclosures of all prior art recited herein are incorporated herein by reference in their entirety. Where a term in the present application is found to be defined differently in a document incorporated by reference, the definition provided herein is to serve as the definition for the term.

### REFERENCES

The following references are provided as examples of known art relating to the present invention. The following listing is not intended to compromise a comprehensive list of all relevant art. The entire contents of all references listed in the present specification, including the following documents, are incorporated herein by reference.

P. G. Bruce, Solid State Ionics, 179, 752 (2008)

R. D. Rauh, K. M. Abraham, G. F. Pearson, J. K. Surprenant and S. B. Brummer, J. Electrochem. Soc., 126, 523 (1979)

J. Shim, K. A. Striebel and E. J. Cairns, J. Electrochem. Soc., 149, A1321 (2002)

X. Ji, K. T. Lee and L. F. Nazar, Nature Materials, 8, 500 (2009)

J. R. Akridge, Y. V. Mikhaylik and N. White, Solid State Ionics, 175, 243 (2004)

S. E. Cheon, S. S. Choi, J. S. Han, Y. S. Choi, B. H. Jung and H. S. Lim, J. Electrochem. Soc., 151, A2067 (2004)

H. Yamin, A. Gorenshtein, J. Penciner, Y. Sternberg and E. Peled, J. Electrochem. Soc., 135, 1045 (1988)

K. Kang, Y. S. Meng, J. Breger, C. P. Grey and G. Ceder, Science, 311, 977 (2006)

J. Wang, S. Y. Chew, Z. W. Zhao, S. Ashraf, D. Wexler, J. Chen, S. H. Ng, S. L. Chou and H. K. Liu, Carbon, 46, 229 (2008)

W. Zheng, Y. W. Liu, X. G. Hu and C. F. Zhang, Electrochem. Acta, 51, 1330 (2006)

J. Wang, J. Yang, C. Wan, K. Du, J. Xie and N. Xu, Adv. Funct. Mater., 13, 487 (2003)

E. Peled, A. Gorenshtein, M. Segal and Y. Sternberg, J. Power Sources, 26, 269 (1989)

D. Aurbach, E. Pollak, R. Elazari, G. Salitra, C. S. Kelley and J. Affinito, J. Electrochem. Soc., 156, A694 (2009)

M. S. Hong, S. C. Han, H. S. Kim, J. H. Kim, K. T. Kim, Y. M. Kang, H. J. Ahn, S. X. Dou and J. Y. Lee, J. Electrochem. Soc., 151, A791 (2004)

Y. J. Choi, B. S. Jung, D. J. Lee, J. H. Jeong, K. W. Kim, H. J. Ahn, K. K. Cho and H. B. Gu, Phys. Scr., T129, 62 (2007)

X. Ji, S. Evers, R. Black and L. F. Nazar, Nature Comm., 2, 325 (2011)

A. Hegazy and E. Prouzet, Chem. Mater., 24, 245 (2012)

M. Holzapfel, A. Martinent, F. Alloin, B. Le Gorrec, R. Yazami and C. Montella, J. Electroanal. Chem., 546, 41 (2003)

M. Bailey and S. Donne, J. Electrochem. Soc., 158, A802 (2011)

J. A. Gladysz, V. K. Wong and B. S. Jick, J. C. S. Chem. Comm., 838 (1978)

C. Yu, J. Fan, B. Tian and D. Zhao, Chem. Mater., 16, 889 (2004)

What is claimed is:

1. A sulfur cathode for use in a rechargeable battery the cathode comprising:
a) an electroactive sulfur-containing material,
b) an electrically conductive filler, and
c) a non-electroactive component;
wherein the non-electroactive component is porous, and has one or more of :
i) pore dimensions that permit absorption of a polysulfide anion or ii) active sites for polysulfide adsorption; and
wherein the absorption and/or adsorption is reversible.

2. The cathode of claim 1 further comprising a binder.

3. The cathode of claim 1 wherein the non-electroactive component is an additive.

4. The cathode of claim 1 wherein the non-electroactive component is formed in-situ in the conductive filler.

5. The cathode according to claim 1, wherein said non-electroactive components are of a unit pore volume larger than 0.1 cm³/g.

6. The cathode according to claim 1, wherein said non-electroactive components have an average pore size in a range from 1 Å to 100 μm.

7. The cathode according to claim 1, wherein said non-electroactive components are of electrical conductivity less than 1.0 S/cm.

8. The cathode according to claim 7 wherein the conductivity of the non-electroactive component is less than 0.1 S/cm.

9. The cathode according to claim 1, wherein said non-electroactive components are of surface area larger than 10 m²/g.

10. The cathode according to claim 1, wherein said non-electroactive components exhibit particle size in a range from 1 nm to 100 μm.

11. The cathode according to claim 1, wherein said non-electroactive components occupy a weight percentage in the cathode in a range from 1% to 50%.

12. The cathode according to claim 3, wherein said non-electroactive components are finely mixed with other components in the cathode.

13. The cathode according to claim 3, wherein said non-electroactive components are dispersed as a separate layer from the mixture of other components of the cathode.

14. The cathode according to claim 1, wherein said non-electroactive components include one or more materials selected from the group consisting of zeolites, supramolecular metal organic frameworks, carbon hydrates, cellulose, biomass, chitosan, non-metallic metal oxides, metal sulphates, non-metallic metal nitrides, carbon nitrides, metal nitrates, nonmetallic metal phosphides, metal phosphates, metal carbonates, non-metallic metal carbides, metal borides, metal borates, metal bromides, metal bromates, metal chlorides, metal chlorates, metal fluorides, metal iodides, non-metallic metal arsenides, metal hydroxides, molecular metal organic-ligand complexes, nonconducting polymers.

15. The cathode according to claim 1, wherein said non-electroactive component comprises one or more of Si, Al, Ti, Ta, Nb, Ge, Ga, Sn, Sb, P or S as the oxide, nitride, oxynitride, carbide or sulfide.

16. The cathode according to claim 1, wherein said non-electroactive components are of a contact angle with water droplet less than 90°.

17. The cathode according to claim 1, wherein said electroactive sulfur-containing materials comprises elemental sulfur or sulfur containing compounds.

18. The cathode according to claim 1, wherein said electrically conductive filler includes one or more materials selected from conductive carbons, graphites, activated carbons, metal powders, electrically conductive polymers, polymer tethered carbons, conducting metal oxides, conducting phosphides, and conducting sulfides.

19. A rechargeable battery comprising:
a. an anode
b. a separator
c. a non-aqueous electrolyte
d. A sulfur cathode as defined in claim 1.

20. A rechargeable battery according to claim 19 wherein the anode comprises sodium, lithium or magnesium.

21. A rechargeable battery according to claim 20 wherein the anode comprises lithium.
